(19) United States
(12) Patent Application Publication
(10) Pub. No.: US 2019/0301193 A1
(43) Pub. Date: Oct. 3, 2019

(54) SYSTEM AND METHOD TO REDUCE ACCELERATIONS EXPERIENCED BY OBJECTS IN VARIABLE ACCELERATION ENVIRONMENTS

(71) Applicants: Lief Cameron MacTavish, Cumberland (CA); James Cameron MacTavish, Cumberland (CA)

(72) Inventors: Lief Cameron MacTavish, Cumberland (CA); James Cameron MacTavish, Cumberland (CA)

(73) Assignee: Lief MacTavish, Cumberland (CA)

(21) Appl. No.: 16/371,069

(22) Filed: Mar. 31, 2019

Related U.S. Application Data
(60) Provisional application No. 62/651,818, filed on Apr. 3, 2018.

(51) Int. Cl. E04H 9/02; G01V 1/28

(52) U.S. Cl. CPC E04H 9/021; G01V 2210/6161; G01V 2210/63; G01V 1/288

(57) ABSTRACT

The current invention enables a structure to remain virtually motionless while the ground underneath it is undergoing significant oscillatory accelerations, such as would occur during a tectonic event. This is achieved by using the Meissner effect to maintain controlled elevation of the structure above the ground, allowing the ground to oscillate underneath the structure. The structure is able to move virtually without friction along an array of symmetric and parallel magnetic fields, which are kept parallel to the axis of ground oscillation typically via input from accelerometers in the surrounding oscillating ground. Simple buffering mechanisms keep the elevated structure from moving beyond the lateral range of the parallel magnetic fields, and facilitate the structure's return to its rest position. In this manner, structural damage from high energy large amplitude earthquakes can be virtually eliminated. This system and method can be extended to any object in a vibrational environment.

### CROSS REFERENCE TO RELATED APPLICATION

The present application claims priority to the earlier filed provisional application having application No. 62/651,818 and a filing date of Apr. 3, 2018, and hereby incorporates the subject matter of the provisional application in its entirety.

### FIELD OF THE INVENTION

The present invention is a system and method of minimizing the accelerations of objects or structures, resulting from accelerations occurring in the supporting environment of those objects or structures. An example would be that of minimizing the accelerations experienced by a building when the ground underlying the building is undergoing marked oscillations due to tectonic activity. Using this system, the accelerations experienced by a structure during a Modified Mercalli Intensity (MMI) Scale level X+ seismic event, which would cause total destruction of most masonry structures, would be reduced to the equivalent of a MMI Scale level III-IV event, in which for example windows may rattle and doors may swing.

### BACKGROUND

An object such as a vehicle or building can experience accelerations during a seismic event that can lead to complete destruction of that object. There are various approaches to optimizing the seismic performance of structures, which can largely be divided into two categories: 1) Non-base isolation and 2) Base isolation.

Non-base isolation strategies primarily involve the application of various types of mass dampers, eg. friction, visco-elastic, hydraulic, or tuned mass dampers. Most damping systems have a limited response to significant oscillations, and usually provide no protection from vertical oscillations. They also have marked deteriorations in performance at low temperatures. Some brands of viscoelastic dampeners have been banned from use in the USA due to reliability concerns.

Base isolation techniques are state-of the-art and widely applied, employing some form of a suspension system between a structure (or object) and the ground (or supporting surface). The premise of base isolation is that the surface below moves but transmits minimal motion to the supported structure above. Base isolation strategies are varied but primarily involve either elastomeric rubber/lead bearings, simple roller bearings, friction pendulum bearings, or springs-with-damper base isolation.

Elastomeric rubber/lead bearings are basically like rubber grommets with lead cores installed for example between a building and its underlying structure. The issue with these bearings is that by design they are very limited in the protection they can provide in the setting of marked lateral movements or excessively cold temperatures.

Simple roller bearings allow more lateral motion, however they provide no protection from vertical oscillations. Their efficacy is very sensitive to particulate contamination of their surfaces and of the base surfaces, such as occurs in the setting of marked tectonic activity. They require lateral dampening, which can lead to failure due to resonance conditions.

Friction pendulum bearings provide minimal protection from vertical oscillations. The protection from lateral motion that they provide is dependent on the coefficients of friction within the system. These coefficients in the real world, as opposed to the shake table, are quite variable due to the oscillating vertical loads experienced during actual seismic events. This leads to marked degradations in these systems' actual performances.

Spring-based isolation systems tend to only be used in supporting machinery, due to ongoing oscillations typically experienced in these systems during normal day to day service loads and insignificant seismic events.

Currently there is no solution for protecting objects or structures from seismic events where there are large lateral oscillations, especially when these lateral oscillations are accompanied by vertical oscillations, as the vertical oscillations can not only cause damage to a structure, but just as importantly can increase the friction within state-of the-art base isolations systems, leading to marked degradation in performance of these systems resulting in increased damage to the structures they purport to protect.

The present invention seeks to provide a solution to these problems by employing a system whereby objects or structures can glide above a surface experiencing large amplitude oscillations in the horizontal plane with infinitesimal friction that is virtually independent of any loads generated by the presence of significant vertical oscillations.

### BRIEF SUMMARY OF THE INVENTION AND ADVANTAGES

The present invention seeks allow objects or structures to glide above a surface environment which is experiencing large amplitude oscillations in the horizontal plane with infinitesimal friction that is virtually independent of any loads generated by the presence of significant vertical oscillations in that environment.

This is achieved in part by Meissner effect elevating the structure or object, which is accomplished by employing high temperature superconductors, and calculating and creating planes of magnetic homogeneity in response to differential inputs from position sensors and accelerometers which are located on the structure and the oscillating surface or ground. The interactions between the high temperature superconductor (HTS) and the homogeneous magnetic field planes allow the object to freely “quantum glide” with minimal if any friction in virtually any direction, regardless of the amplitude of motion of the surface under the object, with the coefficient of glide friction independent of vertical oscillations. The object can also be slowed in its glide towards the end of the glide area by a phenomenon we call “quantum braking.”

Thus in our present invention objects or structures are markedly protected from damage by isolating them from accelerative forces in the surrounding environment.

The present invention in one of its embodiments comprises a layer of HTS attached to the underside of an object or structure, in a plane parallel to and above array of direct current electromagnets, which are affixed to or supported by the ground or surface or surface structure or even to another structure or object. The electromagnets can be non-superconducting or superconducting. If the HTS is below its critical temperature Tc and hence superconducting, then the introduction of electric current into the electromagnets will cause the HTS to generate an opposing magnetic field via Lenz's Law as applied to superconductors, known as the Meissner Effect. This effect will lift the HTS and hence the object or structure above the electromagnet array.

In our invention the electromagnet array mounted on the surface can instantaneously select and create parallel magnetic vector potential fields in planes perpendicular to the plane of the surface foundation. Symmetry and homogeneity in the magnetic field vectors allow the field lines elevating the structure to propagate without friction through the HTS matrix. The orientation of the lines of intersection of the magnetic field planes with the surface foundation is determined by the instantaneously selected relative magnitude and direction of the direct current applied to each individual coil of the electromagnet array.

This propagation of field lines through the HTS takes advantage of impurities which are found in most HTSs. A swirl of electrical current (called a vortex or fluxon) forms around such impurities and allow strands of the magnetic flux to penetrate the superconductor. The rest of the superconductor, without impurities, is still expelling the rest of the magnetic field (causing repulsion) via the Meissner Effect. If the magnetic flux planes are in the same direction throughout the HTS, then the vortices generated in the HTS along these planes will be identical. If the HTS moves parallel to the tops of the magnets in a direction indicated parallel to these flux planes, and there is good magnetic field homogeneity, then minimal if any energy is required to create new vortices. Thus, as the superconductor moves along the direction of these planes, the magnetic field lines elevating the structure can propagate virtually without friction through the superconducting matrix, and the superconductor can glide with only infinitesimal friction back and forth along the direction of magnetic flux plane symmetry. We take advantage of this phenomenon (which we call “quantum gliding”) in this invention, as it enables structures or objects to be protected from damage while the environment around the structures or objects is undergoing extreme oscillations.

The magnetic field planes, and hence the direction of glide of the objects or structures, are kept continually parallel to the direction of motion of the surface or ground, as determined by differential inputs from position sensors and accelerometers attached to the structure and embedded in the surface or ground. As such, objects or structures supported by the magnetic field generated by the superconductor can remain virtually motionless above the surface, despite motions in the horizontal plane of the surface of tremendous amplitude. This is a phenomenal advantage over current methodologies.

In the electromagnet embodiment of this invention, the direction of glide is changeable, and defined which lines of electromagnets are selected to be activated. These lines of activation generate the parallel magnetic flux planes perpendicular to the surface, and can be created by the array in virtually any axis parallel to the surface foundation as needed to match the direction of ground motion. Thus the structure experiences in our experiments Modified Mercalli Intensity (MMI) Scale level III or IV accelerations in MMI Scale level X+ environments in any plane parallel to the ground. No other isolation system yet invented can protect the supported structures or objects from such extreme accelerations as the present invention can.

Surface oscillations not parallel to the plane of the surface foundation are dampened by the supporting magnetic field naturally generated by the superconductor, and can be further mitigated by selective alteration in the magnitude of the magnetic coil field strengths.

In the present invention, quantum gliding friction is infinitesimal and is independent of vertical oscillations. This is a significant advantage over systems involving friction pendulums, whose performance is markedly degraded in the presence of vertical oscillations.

Another advantage of the present invention is that low mass objects, or objects in low or microgravity environment, are not only supported by the Meissner Effect above the track, but are prevented from being accelerated vertically away from the track and beyond or away from the magnetic field. High temperature superconductors, through the well known phenomenon of quantum pinning, strongly resist movements away from the magnetic field, as the magnetic flux lines tend to curve above the HTS or in the upper layers of the HTS, and try to penetrate the superconductor at new angles, which the superconductor resists as part of its inherent Meissner Effect properties.

Numerous patents have been developed that purport to dampen the vibration within a system by utilizing this combination of the Meissner effect and quantum pinning. Our accelerometer experiments have shown however that a HTS pinned in non-parallel magnetic fields above a magnet undergoing vibrational or accelerative forces typically experience at least 90% of the magnet's accelerations, and become markedly unstable. Adding load mass to the HTS leads to less oscillations and a slight reduction in the accelerative forces experienced, however the system unfortunately becomes rapidly prone to sudden loss of quantum pinning and uncoupling as mass is added. Attempts to decrease the pinning strength by reducing the magnitude of the magnetic field flux likewise readily lead to sudden pinning failure when oscillations are introduced. In our experiments, multiple resonances in the oscillatory frequencies could always be found that lead to uncoupling/loss of pinning in such systems regardless of the magnetic field strength employed. As such, systems attempting to dampen/decrease oscillatory forces using quantum pinning and the Meissner effect do not work well in practice.

In the present invention, in which the direction of potentially unlimited and virtually frictionless quantum gliding is instantaneously selected to match the horizontal direction of surface oscillations, no uncoupling is experienced, and there are only minimal horizontal plane accelerations experienced by the supported object or structure.

Alternate embodiments of the current invention can be achieved using permanent magnets or superconducting magnets, rather than electromagnets.

Other objects, advantages and novel features, and further scope of applicability of the present invention will be set forth in the detailed description to follow, taken in conjunction with the accompanying drawings, and in part will become apparent to those skilled in the art, upon examination of the following, or may be learned by practice of the invention. The objects and advantages of the invention may be realized and attained by means of instrumentalities and combinations particularly pointed out in the appended claims.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a structure resting above the foundation pad of high temperature superconducting (HTS) material. Also depicted are a central processing unit which controls the magnetic field strength of each electromagnet, and 6-axis accelerometers at various points in the ground outside the structure and attached to the structure.

FIG. 2 illustrates the array of electromagnets attached to inferior aspect of the building, object, or structure. An example of the instantaneous direction of allowable quantum gliding is parallel to the rows of magnetic polarity currently depicted. Electromagnets along axes parallel to these glide paths would be activated.

FIG. 3 depicts a cross section through parallel planes of magnetic fields generated by electromagnets or permanent magnets.

FIG. 4 portrays an oblique view of a plane of magnetic field lines. It is perpendicular to this plane that the direction of quantum gliding occurs.

FIG. 5 is similar to FIG. 1 but for the case of a structure supported by a high temperature superconductor interacting with permanent magnets rather than electromagnets. A platter on the surface supporting the magnet array is made to rotate based on the inputs from position sensors and accelerometers into positions were the planes of the magnetic fields remain parallel to the direction of surface oscillations.

FIG. 6 is an example of an object in a low gravity seismically active environment. It is held above the tray by the Meissner Effect, and is prevented from being jettisoned vertically by the phenomenon of quantum pinning. It is free to glide back and forth along the track during seismic events by the phenomenon of quantum gliding. Towards the ends of the track, magnet strengths and polarities are defined to enable the phenomenon of quantum braking to slow the object gradually if needed. The direction of glide will be parallel to the direction of seismic oscillations, and is computed from input from position sensors and accelerometers on the track and on the surface. The computing devices be inside or outside the object or structure. An armature rotates the track and can also tilt the track if indicated.

FIG. 7 is a top down view of the track depicted in FIG. 6, including position sensors and accelerometers, the direction quantum gliding of the object, the direction of rotation of the track, and magnets which facilitate quantum gliding and quantum braking.

### DETAILED DESCRIPTION OF THE PREFERRED EMBODIMENTS AND BEST MODE OF IMPLEMENTATION

Various example embodiments will now be described more fully, with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section, Thus, a first element, component, region, layer, or section discussed below could be termed a second element, component, region, layer, or section without departing from the teachings of the present invention.

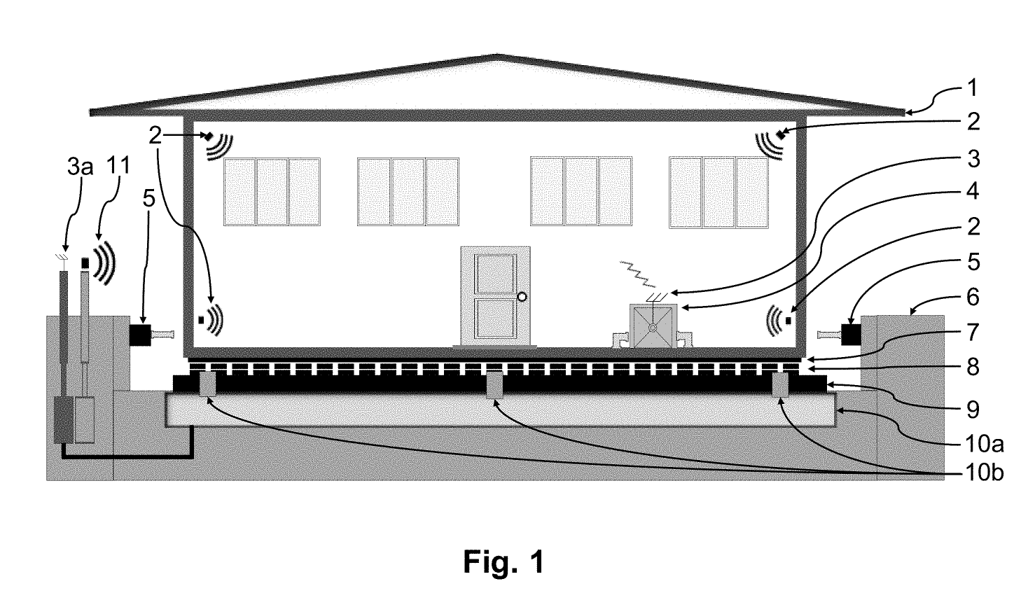

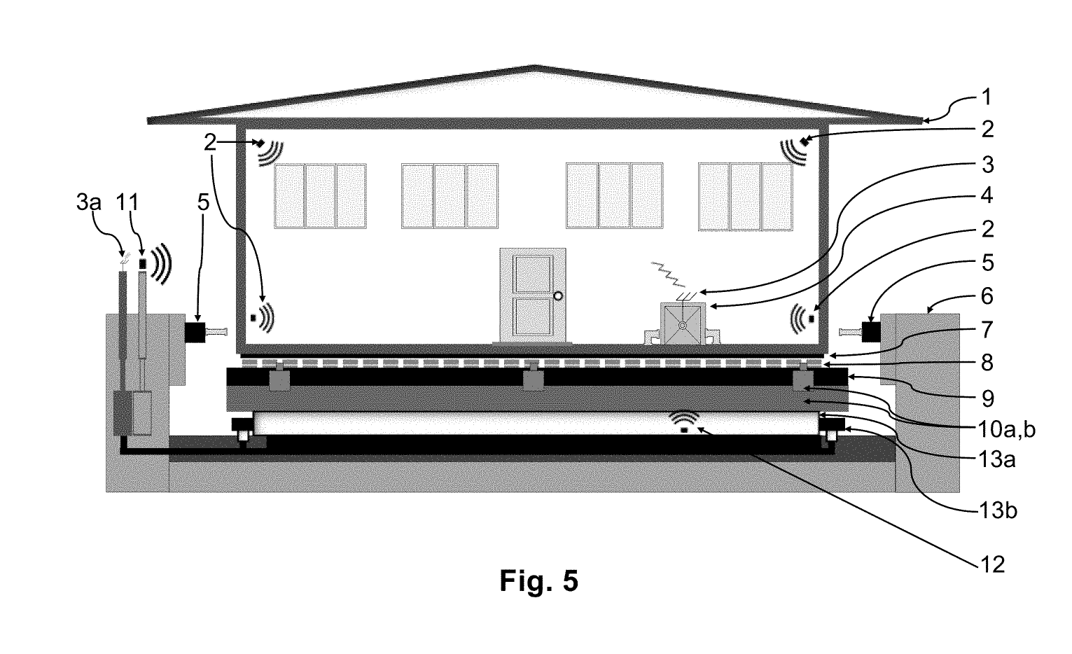

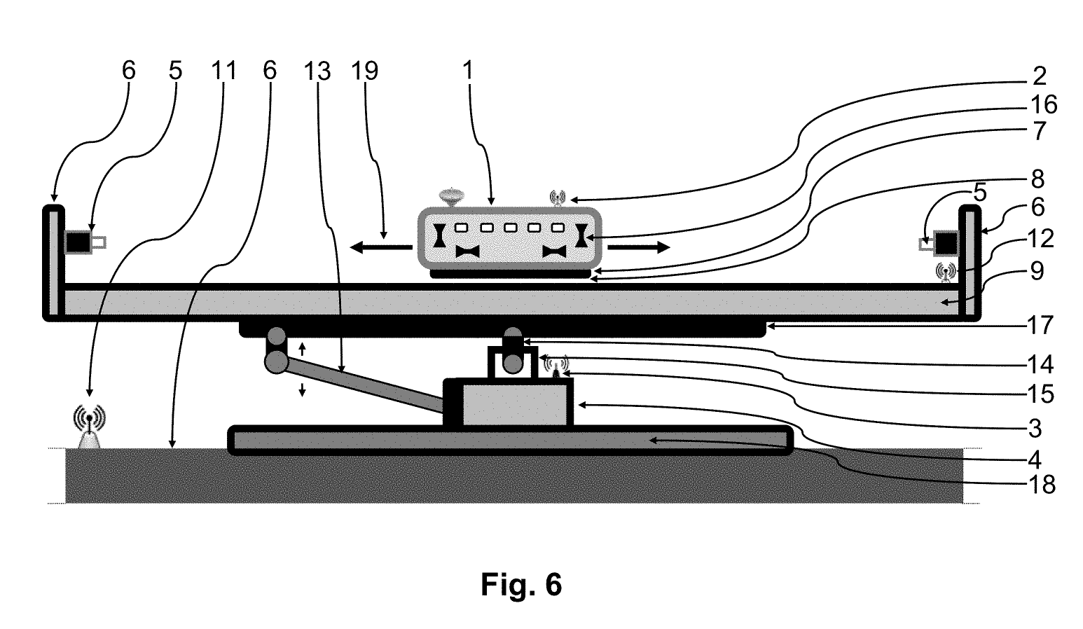

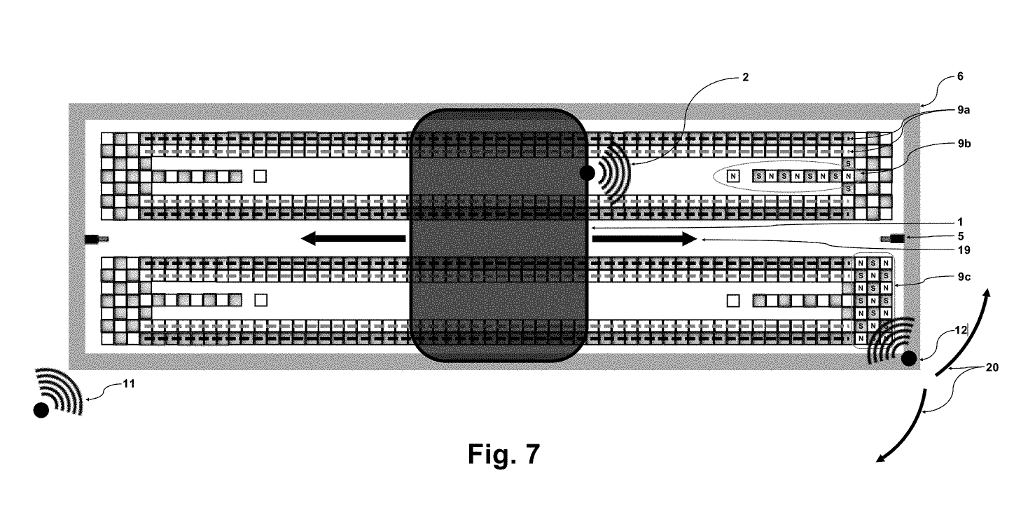

In the present invention an object or structure 1 in FIGS. 1,2,5,6 and 7 is elevated above an array of magnets 9 in FIGS. 1,2,5,6, and 7. This is accomplished through employing a layer of high temperature superconducting (HTS) material which is attached as 7 in FIGS. 1,5, and 6 to the underside of an object or structure in a plane parallel to the bottom of the structure. This HTS material can be kept cooled to below its critical temperature by various means, including liquid nitrogen, which could be circulated by equipment as 4 in FIGS. 1 and 5. As the Tc of high temperature superconductors rises with the development of new superconductors, such cooling equipment ultimately may not be necessary. Additionally in cold environments such as in areas away from Earth, no cooling may be needed such as in the embodiments portrayed in FIGS. 6 and 7.

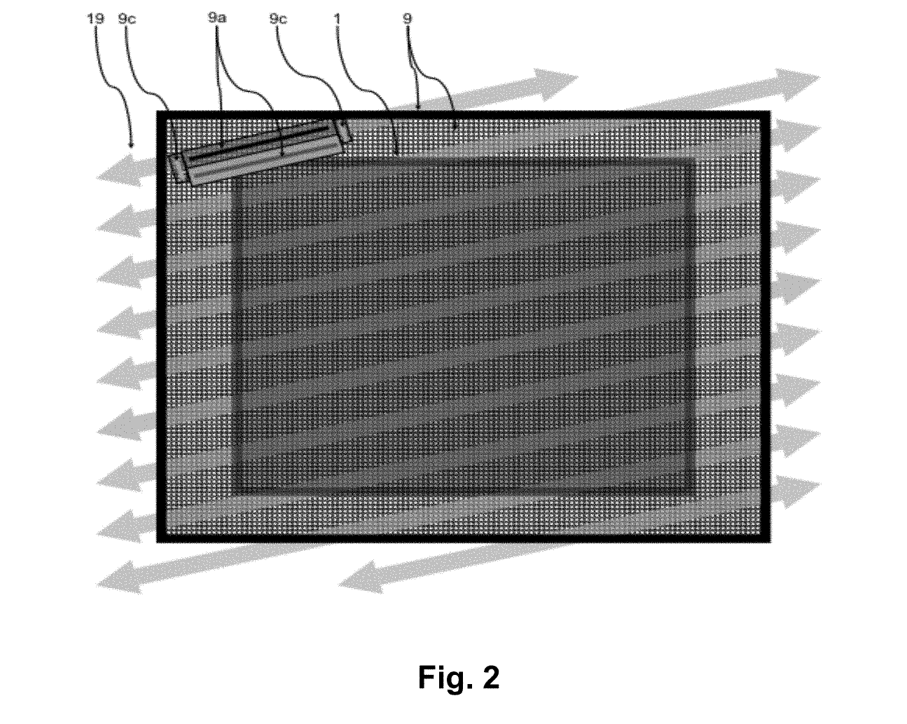

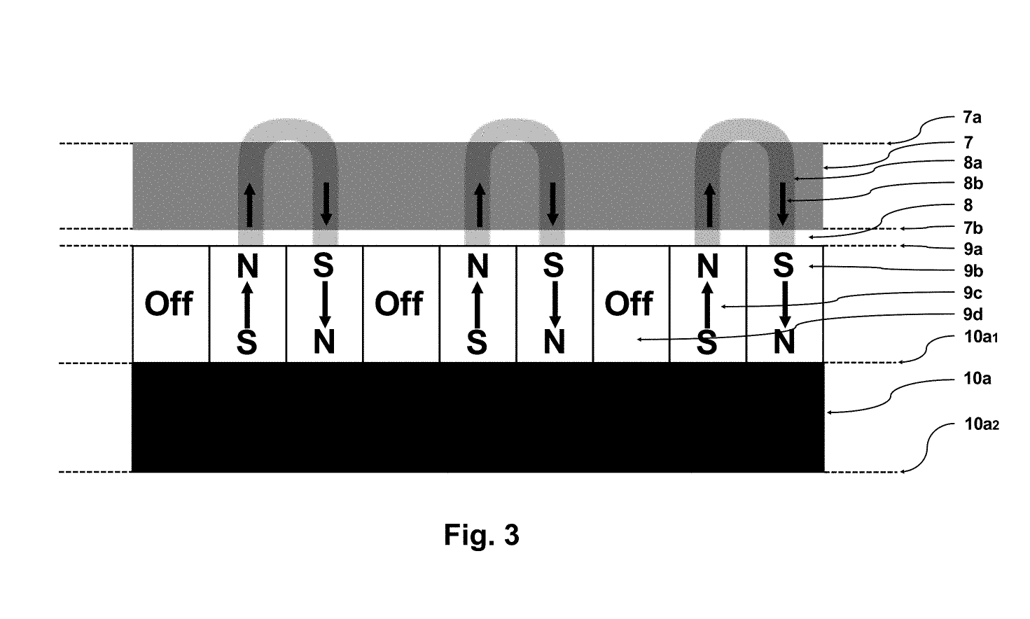

When tectonic activity is detected via remote sensing or by the local sensors 11 as in FIGS. 1, 5, 6 and 7, the array of electromagnets as 9 in FIGS. 1 and 2 is activated. This causes an opposing magnetic field in the superconducting layer as 7 in FIG. 1 which due to the Meissner Effect lifts the object or structure off of its resting bed or pylons as 10b in FIG. 1, creating an actual gap as 8 in FIG. 1 between the object or structure and the magnets 9 below. In the case of permanent magnets as embodied in FIGS. 5, 6, and 7, the superconducting matrix 7 in FIGS. 5 and 7 can hold the object or structure 1 Meissner effect elevated indefinitely, or the structure can be maintained on retractable pylons 10a in FIG. 5 which are supported by a base layer 10b in FIG. 5. Note that if the matrix 7 is above Tc and then is allowed to rest directly on the magnet layer 9, and then matrix 7 is cooled below Tc, then the superconducting matrix 7 will be quantum pinned to the surface because the matrix will subsequently resist any penetration of the arcing changing magnetic field flux 8a in FIG. 3 from penetrating the matrix 7. The matrix 7 must be kept above the surface of the magnets 9 unless it is maintained below Tc.

Accelerometers as 11 in FIGS. 1,5,6, and 7 determine the direction of surface oscillations and send this information processing units 3 and/or 3a in FIGS. 1 5, and 6. In the FIG. 6 embodiment, the processing unit(s) 3 may be on board. This information allows the processing unit(s) to instantaneously determine the horizontal direction of oscillation of the surface, which would be such as 19 in FIG. 7.

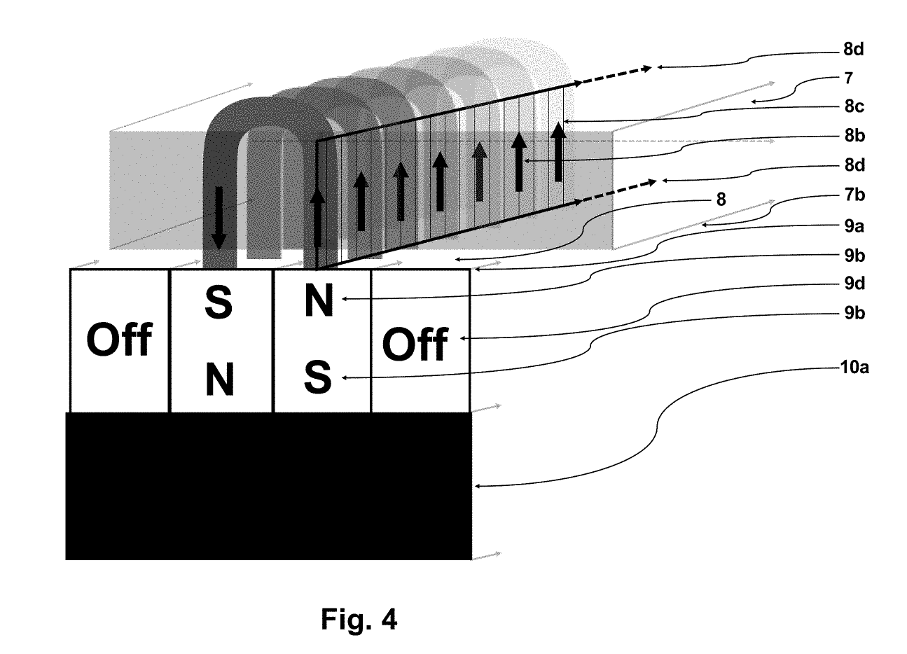

The electromagnetic array as 9 in FIGS. 1 and 2 can instantaneously create parallel magnetic vector potential fields such as 9a in FIG. 2, in planes that are selected perpendicular to the surface foundation, as illustrated as 8c in FIG. 4. Symmetry and homogeneity in the magnetic field vectors 8b as in FIGS. 3 and 4 is created by arranging or polarizing the magnets such that there are strong magnetic field lines as 8a in FIG. 3 which are kept localized by arranging or polarizing pairs of magnets such that magnets of opposite polarity are adjacent to each other as 9b and 9c in FIG. 3, and, that such pairs are separated by such regions of minimal magnetic activity as 9d in FIGS. 3 and 4 to minimize flux 8a travel between adjacent rows. Symmetrical homogenous field lines as 8b in FIGS. 3 and 4 thus flow through the HTS as illustrated as 7 in FIGS. 3 and 4. It is parallel to the direction of these planes of homogeneity 8c back and forth along the dashed vectors 8d in FIG. 4 that the HTS can move virtually without friction.

This phenomenon takes advantage of impurities which are found in most high temperature superconductors. A swirl of electrical current (called a vortex or fluxon) forms around such impurities and allow strands of the magnetic flux to penetrate the superconductor. The rest of the superconductor, without impurities, is still expelling the rest of the magnetic field (causing repulsion) via the Meissner Effect. If the magnetic flux as 8a in FIGS. 3 and 4 is in the same direction throughout a plane as 8c in FIG. 4 of the superconductor 7 in FIG. 4, then the vortices through the superconductor from 7b to 7a (or vice versa) as in FIGS. 3 and 4 along that plane 8c in FIG. 4 will be identical. If the high temperature superconductor 7 moves parallel to the tops of the magnets as 9a in FIG. 4, in a direction indicated by the dashed arrows as 8d in FIG. 4, and there is good magnetic field homogeneity, then minimal if any energy is required to create new vortices. Thus as the superconductor moves along the direction 8d the magnetic field lines elevating the structure can propagate virtually without friction through the superconducting matrix, and the superconductor can slide virtually without friction back and forth along the direction defined by 8d, the phenomenon we call “Quantum Gliding.”

The magnetic field planes 8c in FIG. 4, and as 9a in FIG. 2, and hence the direction of glide as 19 in FIGS. 2, 6, and 7 are kept continually parallel to the direction of motion of the surface, because the accelerometers as 11 in the figures instantaneously determine the directions of motion of the surface caused by tectonic or other forces, and calculate the strengths and polarities of the individual electromagnetic field vectors that the array needs to generate to facilitate the quantum gliding of the moving foundation under the structure. Note that changes in the direction of motion of the foundation can be readily accommodated as the direct current electromagnets can be rapidly adjusted given the virtual absence of inductive reactance in the system. Vertical loads generated by non-horizontal surface oscillations do not affect quantum gliding if the magnetic fields are strong enough to maintain elevation of the object.

In the embodiment of our invention in FIGS. 1 and 5 the superconducting foundation extends out in all directions beyond electromagnet array to enable adequate quantum glide length along the direction of ground oscillation. As horizontal ground oscillations in earthquakes on earth are typically less than 30 cm, a 50 cm extension of superconducting matrix beyond the magnetic array in all directions may be adequate facilitate any extent needed of quantum gliding. The effective quantum glide path can however be extended many meters if needed, to accommodate extreme surface oscillations if indicated.

In this invention, position sensors as 2 are incorporated to sense excursions of the building along the superconducting foundation to detect whether the building does is getting close to the endpoints of the foundation. Physical spring or hydraulic pistons as 5 in FIGS. 1, 5, 6, and 7 could easily be installed in such a manner as to prevent the structure from floating off of the edge of the superconducting surface in the case of extreme ground oscillations or an induced change in slope of the supporting surface. Such pistons however could still lead to rapid deceleration of the structure as the endpoints are encountered and the possible development of a destructive resonance condition.

In this invention, this possibility is mitigated by the introduction of what we will call quantum braking. Quantum braking is facilitated by introducing planes of magnetic field vectors into the superconducting matrix that are perpendicular or at least not parallel to the field plane direction along which the structure is quantum gliding.

These perpendicular magnetic field planes, as 9c in FIG. 2, the intensity and direction of which are computed via information from the position sensors 2 and accelerometers 11, are gradually introduced by processing units 3/3a in such a manner in the magnetic array to slow the building down in a calculated fashion before it reaches a hydraulic endpoint. This slowing occurs because the superconducting matrix 7 will expel magnetic flux attempting to penetrate its structure except those flux lines 8a co-incident and parallel to the previously established planes such as 8c or 9a and 9b, for which vortices (or fluxons) have already been created. Using quantum gliding and quantum braking, our experiments have enabled structures of various heights and masses above foundations to experience MMI Scale level III or IV accelerations with no resonance modes detected while the surrounding environment is undergoing spontaneous accelerations of 9 g's at frequencies ranging from 0.1 Hz to 200 Hz.

With respect to tectonic forces in the vertical plane, vertical oscillatory forces typically do not necessarily in and of themselves cause significant damage to structures relative to the motions of the horizontal ground plane. The present invention in its electromagnet embodiment incorporates the ability of the magnitude of the magnetic field across the array to be alternatively strengthened and weakened within limits in response to differential accelerations sensed by the digital 6 axis accelerometers in the vertical direction.

In embodiments of the present invention using permanent magnets, as in FIGS. 5, 6, and 7, the polarity and strength of the magnetic fields of each magnet is not altered as it can be in the electromagnetic embodiment. The direction of magnetic field planes is kept parallel to the direction of surface oscillations by physically rotating the magnet array and tray 9 such that the direction of physically allowable quantum gliding such as along the lines 9a, 9b, and 19 in FIG. 7 is maintained parallel to the direction of horizontal surface oscillations. This optimal direction is sensed and calculated by position sensors and accelerometers as per in the electromagnet embodiment of this invention.

Consider FIG. 5. A position sensor accelerometer 12 transmits data to the processing units 313a, which then rotate the platter 13a by methods such as a roller or gear mechanism 13b. The platter is rotated as needed to a position where the structure 1 can quantum glide back and forth along the homogeneous magnetic flux generated by the permanent magnet tracks as in 9a in FIG. 7. Passive quantum braking can be employed toward the lateral ends of such tracks by gradually introducing non-parallel/inhomogeneous magnetic flux as 9b in FIG. 7. Marked quantum braking can be elicited by introducing a significantly inhomogeneous magnetic flux such as in the configuration of 9c in FIG. 7.

FIGS. 6 and 7 demonstrate an embodiment of this invention where extreme horizontal oscillations in the environment are expected, in which case the object 1 will protected by being allowed to transverse back and forth along most of the length of the track and magnet array 9, in the directions 19.

The object has a layer of HTS plating 7 on its underside which can be kept below Tc via cooling equipment/liquid N2 and so on, or it can be below Tc in a naturally cold environment away from earth. The craft can land or take off from the track using its maneuvering thrusters 7. If the superconducting matrix 7 is below Tc then not only will the craft be supported by the repulsive magnetic field generated by the superconductor, but it will be held to the track a distance as in 8 away until the object warms the superconductor above Tc. This is because of the phenomenon of quantum pinning described above where the superconductor resists the introduction of magnetic flux not parallel to 9a, such as is the case with the curving flux lines farther away from the magnet. This is an advantage in this embodiment of the present invention because the craft is held to the surface in an extremely low gravity yet highly tectonically active environment.

The track direction is determined by position sensor/accelerometer inputs as in the embodiment of FIG. 5. The track 9 is rotated in the directions 20 as needed to maintain the directions of motion 18 parallel to the horizontal direction of surface oscillations. Rotation is accomplished by a rotating unit 4 which is driven by a ground support unit 18. A universal joint connection system 14 and 15 allows the magnet tray 9 to tilt via the action the control arm 13, in response to slow the object 1 if needed, or to mitigate the effect of vertical oscillations.

Earthquakes can inflict substantial damage and some of the most damaging earthquakes in history are known to have lasted less than 30 seconds. Current HTS's typically require longer than 30 seconds to cool below their critical superconducting temperature (Tc) with liquid nitrogen. Thus, to be instantaneously ready for a severe tectonic event, the surface layer of the foundation containing the HTS material should be kept below the temperature at which it becomes superconducting (Tc). This process will become progressively simplified as superconducting materials are developed that approach room temperature limits.

1. A system and method for isolating a structure on or above the underlying ground, surface, or underlying structure during a seismic or significant vibrational event comprising:
(a) monitoring the movements of the structure as well as the underlying ground, surface, or underlying structure; and
(b) from the movements of the underlying ground or underlying surface, or underlying structure, determining the onset of a seismic or significant vibrational event; and
(c) from the movements of the underlying ground or underlying surface, or underlying structure, determining the direction or directions of oscillation of a seismic or significant vibrational event; and
(d) in response to the determination of the onset and direction of a seismic or significant vibrational event, connecting a source of DC power to an array of electromagnets attached to the underlying ground, surface, or underlying structure such that in response to connecting the DC power to said array, electromagnets are selectively activated in rows parallel to the direction underlying ground or underlying surface, or underlying structure oscillation, generating rows of parallel symmetrical magnetic fields perpendicular to the underlying ground, surface, or underlying structure; and
(e) a layer of high temperature superconducting (HTS) material at a temperature below its critical temperature (Tc) with said HTS material being located within or attached to the lower surface of the structure to be isolated, and generating Meissner effect repulsion from the magnets; and
(f) in response to detecting said Meissner effect repulsion, and using a mechanism to attach, support, or disconnect the structure to be isolated from the underlying ground, surface, or underlying structure, release or disconnect the structure to be isolated; and
(g) in response said the symmetrical magnetic fields, which penetrate the HTS layer at the locations of the impurities inherent in such HTS, with said penetration including the creation of fluxons being generated in a pattern of lines parallel to the direction of oscillation of the underlying ground or underlying surface, or underlying structure; and
(h) in response to the establishment of said linear arrangements of fluxons, the structure can remain virtually motionless above the oscillating underlying ground or underlying surface, or underlying structure, which moves beneath the HTS layer without exerting any friction upon it in the direction of said oscillations; and
(i) in response to any oscillations beyond the length of the array of electromagnets, the Meissner effect elevated structure can be allowed to contact buffering structures around its periphery to prevent propagation of the said elevated structure beyond the dimensions of the electromagnetic array; and
(j) in response to the detection of the cessation of said seismic or significant vibrational event, said buffering structures can if needed return the Meissner effect elevated structure back to its rest position, where using a mechanism to attach, or support the structure above the underlying ground, surface, or underlying structure, re-connect the structure to the underlying ground, surface, or underlying structure.

2. The method of claim 1, wherein the method further comprises maintaining the connection of the DC power source to the array of electromagnets for the entirety of the duration of the seismic or significant vibrational event, and such time as to have the Meissner effect elevated structure repositioned if needed to its rest position.

3. The method of claim 1, wherein the movement of the underlying ground, surface, or underlying structure is monitored by one or more accelerometers which produce output signals corresponding to the movement of the underlying ground, surface, or underlying structure, and the onset of a seismic or significant vibrational event is predicted by means of a computer or microprocessor running an algorithm using the output signals.

4. The method of claim 1, wherein the movement of the underlying ground, surface, or underlying structure is monitored and the onset of seismic or significant vibrational events is predicted by a mechanical device comprising a pendulum mass that actuates or de-actuates a switch when subjected to early arrival underlying ground, surface, or underlying structure motions preceding the onset of a seismic or significant vibrational event.

5. The method of claim 1, wherein the movement of underlying ground, surface, or underlying structure is monitored and the onset of a seismic or significant vibrational events is predicted by a mechanical device comprising a sliding mass that actuates or de-actuates a switch when subjected to early arrival motions of the underlying ground, surface, or underlying structure preceding the onset of a seismic or significant vibrational event.

6. The method of claim 1, wherein the movement of underlying ground, surface, or underlying structure is monitored and the onset of a seismic or significant vibrational event is predicted by a mechanical device consisting of a rotating/rolling mass that actuates or de-actuates a switch when subjected to early arrival seismic or significant vibrational motions preceding the onset of a seismic or significant vibrational event.

7. A system and method for isolating a structure on or above the underlying ground, surface, or underlying structure during a seismic or significant vibrational event comprising:
(a) a power source; and
(b) an array of superconducting or permanent magnets fixed to and above a horizontal platform oriented in a plane underneath and parallel to the underside of the overlying structure to be isolated, with the platform being connected to the underlying ground, surface, or underlying structure via a servo or one or more servos, and with the array of magnets arranged such that the flux vectors of the magnets are not only all perpendicular to said platform, but are also arranged such that the flux vectors define parallel rows of symmetrical magnetic flux along a fixed axis of the platform parallel to the platform's surface; and
(c) a switch interconnecting the power source to the servo; and
(d) one or more seismic or vibration monitors for monitoring the movement of the ground, surface, or underlying structure underneath or adjacent to the structure to be isolated, and from the movement, utilizing one or more computers or microprocessors which are operating either as part of or connected to such monitors, predict the onset of a seismic or significant vibrational event, and determine the direction of oscillations generated from such an event; and
(e) a layer of high temperature superconducting (HTS) material at a temperature below its critical temperature (Tc) with said HTS material being located within or attached to the lower surface of the structure to be isolated, and generating Meissner effect repulsion from the magnets; and
(f) in response to detecting the onset of a seismic or significant vibrational event, and using a mechanism to attach, support, or disconnect the structure to be isolated from the underlying ground, surface, or underlying structure, release or disconnect the structure to be isolated; and
(g) in response to input from one or more microprocessors or computers interpreting data from seismic or vibration monitors, the supporting platform is rotated by one or servos such that the orientation of the to the direction of oscillation of the underlying ground or underlying surface, or underlying structure; and
(g) in response to said the symmetrical magnetic fields, which penetrate the HTS layer at the locations of the impurities inherent in such HTS, with said penetration consisting of fluxons being generated in a pattern of lines parallel to the direction of oscillation of the underlying ground or underlying surface, or underlying structure; and
(h) in response to the establishment of said linear arrangements of fluxons, the structure can remain virtually motionless above the oscillating underlying ground or underlying surface, or underlying structure, which moves beneath the HTS layer without exerting any friction upon it in the direction of said oscillations; and
(i) in response to any oscillations beyond the length of the array of magnets, the Meissner effect elevated structure can be allowed to contact buffering structures around its periphery to prevent propagation of the Meissner effect elevated structure beyond the dimensions of the electromagnetic array; and
(j) in response to the detection of the cessation of said seismic or significant vibrational event, said buffering structures can if needed return the Meissner effect elevated structure back to its rest position, where using a mechanism to attach, or support or reconnect the structure above the underlying ground, surface, or underlying structure or platform, reconnect or attach the structure to the underlying ground, surface, or underlying structure or platform.

8. The system of claim 7, wherein the system further comprises a timer, connected between the seismic or vibration monitor and the switch, which timer is activated by the seismic or vibration monitor in response to the prediction of the onset of a seismic or significant vibrational event, and which timer maintains the connection of the DC power source to the array of electromagnets for a predetermined time relating the expected duration of the seismic or significant vibrational event.

9. The system of claim 7, wherein the movement of the underlying ground, surface, or underlying structure is monitored by one or more accelerometers which produce output signals corresponding to the movement of the underlying ground, surface, or underlying structure, and the onset of a seismic or significant vibrational event is predicted by means of a computer or microprocessor running an algorithm using the output signals.

10. The system of claim 7, wherein the seismic or vibration monitor comprises a mechanical device comprising a pendulum mass that actuates or de-actuates a switch when subjected to early arrival ground, surface, or underlying structure motions preceding the onset of a seismic or significant vibrational event.

11. The system of claim 7, wherein the seismic monitor comprises a mechanical device comprising a sliding mass that actuates or de-actuates a switch when subjected to early arrival ground, surface, or underlying structure motions preceding the onset of a seismic or significant vibrational event.

12. The system of claim 7, wherein the seismic or vibration monitor comprises a mechanical device comprising a rotating/rolling mass that actuates or de-actuates a switch when subjected to early arrival ground, surface, or underlying structure motions preceding the onset of a seismic or significant vibrational event.
